(19) United States
(12) Patent Application Publication
(10) Pub. No.: US 2015/0033637 A1
(43) Pub. Date: Feb. 5, 2015

(54) POLYCRYSTALLINE SUPERHARD MATERIAL AND METHOD OF FORMING

(71) Applicant: Element Six Abrasives S.A., Luxembourg (LU)

(72) Inventor: Kaveshini Naidoo, Springs (ZA)

(21) Appl. No.: 14/387,202

(22) PCT Filed: Mar. 27, 2013
(86) PCT No.: PCT/EP2013/056520

§ 371 Date: Sep. 22, 2014

Related U.S. Application Data
(60) Provisional application No. 61/619,237, filed on Apr. 2, 2012.

(30) Foreign Application Priority Data
Mar. 30, 2012 (GB) 1205716.2

(51) Int. Cl. C04B 35/52; C04B 35/645

(52) U.S. Cl. CPC C04B 35/52; C04B 35/645
USPC 51/309; 51/307

(57) ABSTRACT

A body of polycrystalline diamond (PCD) material having a diamond content of at most 95 percent of the volume of the PCD material, a binder content of at least 5 percent of the volume of the PCD material, and comprising diamond grains having a mean diamond grain contiguity of greater than 60 percent and a standard deviation of less than 2.2 percent is disclosed. Also disclosed is a method of making such a body of polycrystalline diamond material.

### FIELD

This disclosure relates to a polycrystalline diamond (PCD) material, and to a method of making a body of PCD material.

### BACKGROUND

Cutter inserts for machine and other tools may comprise a layer of polycrystalline diamond (PCD) bonded to a cemented carbide substrate. PCD is an example of a superhard material, also called superabrasive material, which has a hardness value substantially greater than that of cemented tungsten carbide.

Components comprising PCD are used in a wide variety of tools for cutting, machining, drilling or degrading hard or abrasive materials such as rock, metal, ceramics, composites and wood-containing materials. PCD comprises a mass of substantially inter-grown diamond grains forming a skeletal mass, which defines interstices between the diamond grains. PCD material comprises at least about 80 volume % of diamond and may be made by subjecting an aggregated mass of diamond grains to an ultra-high pressure of greater than about 5 GPa, typically about 5.5 GPa, and temperature of at least about 1200° C., typically about 1440° C., in the presence of a sintering aid, also referred to as a catalyst material for diamond. Catalyst material for diamond is understood to be material that is capable of promoting direct inter-growth of diamond grains at a pressure and temperature condition at which diamond is thermodynamically more stable than graphite. Some catalyst materials for diamond may promote the conversion of diamond to graphite at ambient pressure, particularly at elevated temperatures. Examples of catalyst materials for diamond are cobalt, iron, nickel and certain alloys including any of these. PCD may be formed on a cobalt-cemented tungsten carbide substrate, which may provide a source of cobalt catalyst material for the PCD. The interstices within PCD material may at least partly be filled with the catalyst material.

WO 2010/140108 discloses a polycrystalline diamond (PCD) material comprising at least 88 volume percent and at most 99 volume percent diamond grains, and having a mean diamond grain contiguity of greater than about 60 percent. The PCD is manufactured at ultra high pressures of 6 GPa or higher to increase diamond contiguity resulting in improved wear performance.

U.S. Pat. No. 7,516,804 and U.S. patent application publication number 2009/0158670 disclose a superabrasive element that includes a mass of polycrystalline diamond including ultra-dispersed diamond grain structures present in an amount greater than zero weight percent and less than about 75 weight percent of the mass of polycrystalline diamond.

### SUMMARY

Viewed from a first aspect there is provided a body of polycrystalline diamond (PCD) material having a diamond content of at most about 95 percent of the volume of the PCD material, a binder content of at least about 5 percent of the volume of the PCD material, and comprising diamond grains having a mean diamond grain contiguity of greater than about 60 percent and a standard deviation of less than about 2.2 percent.

In some embodiments, the PCD material may comprise diamond grains having a mean diamond grain contiguity of greater than 60.5 percent, at least about 61.5 percent or even at least about 65 percent.

In some embodiments, the diamond grains may have a mean diamond grain contiguity of at most about 80 percent or at most about 77 percent.

The mean diamond grain contiguity may, in other embodiments, be in the range from 60.5 percent to about 77 percent, and in other embodiments, the mean diamond grain contiguity may be in the range from 61.5 percent to about 77 percent.

In some embodiments, the diamond content of the polycrystalline diamond material may be at least about 80 percent, at least about 82 percent, at least about 84 percent, or even at least about 85 percent of the volume of the polycrystalline diamond material. In one embodiment, the diamond content of the polycrystalline diamond material is at most about 88 percent of the volume of the polycrystalline diamond material.

In some embodiments, the content of the binder material is at least about 12 volume percent, at least about 13 volume percent, or even at least about 14 volume percent of the PCD material.

In one embodiment, the PCD material may comprise diamond grains having a multi-modal size distribution, comprising two or more different average diamond grain sizes.

Viewed from another aspect, there is provided a wear element comprising the body of polycrystalline diamond material defined above.

An embodiment may provide a tool or tool component for cutting, boring into or degrading a body, comprising an embodiment of the body of PCD material defined above. In some embodiments, the tool or tool component may be for cutting, milling, grinding, drilling, earth boring, rock drilling or other abrasive applications, such as the cutting and machining of metal. In one embodiment, the tool component may be an insert for a drill bit, such as a rotary shear-cutting bit, for boring into the earth, for use in the oil and gas drilling industry. In one embodiment, the tool may be a rotary drill bit for boring into the earth.

In one embodiment, an insert comprises an embodiment of the body of PCD material defined above, the body of PCD material being bonded to a cemented carbide substrate and the insert being for a drill bit for boring into the earth.

In one embodiment, the tool component may comprise an embodiment of a PCD material bonded to a cemented carbide substrate at an interface. The PCD material may integrally be formed with the cemented carbide substrate and the interface may be, for example, substantially planar or substantially non-planar. In some embodiments, the PCD material may define a working surface having a chamfered edge.

Viewed from another aspect, there is provided a method for making the body of polycrystalline diamond material defined above, the method including providing a fraction of diamond particles or grains and a sintering additive, the sintering additive comprising a carbon source of nano-sized particles or grains, forming the diamond particles or grains and sintering additive into an aggregated mass, consolidating the aggregated mass and a binder material, typically a catalyst material for diamond, to form a green body, and subjecting the green body to conditions of pressure and temperature at which diamond is more thermodynamically stable than graphite and for a time sufficient to consume the sintering additive, sintering it and forming the body of polycrystalline diamond material that is thermodynamically and crystallographically stable and is substantially devoid of any nano-structures, the body of polycrystalline diamond (PCD) material having a diamond content of at most about 95 percent of the volume of the PCD material, a binder content of at least about 5 percent of the volume of the PCD material, and comprising diamond grains having a mean diamond grain contiguity of greater than about 60 percent and a standard deviation of less than about 2.2 percent.

In some embodiments, the sintering additive is nanodiamond. The nanodiamond may be UDD, PDD or a crushed source of nanodiamond.

In some embodiments, the sintering additive is a nano-sized carbon source selected from the group comprising graphite, soot, coke, carbon anions and fullerenes.

In some embodiments, the sintering additive is provided in an amount of from about 0.01 to about 5 wt %, or from about 0.5 to about 1 wt %, or up to about 50 wt %.

In some embodiments, the method includes subjecting the green body to a pressure treatment at a pressure of greater than 6.0 GPa, at least about 6.2 GPa, or at least about 6.5 GPa, or even at about 6.8 GPa or more, in the presence of a metallic catalyst material for diamond at a temperature sufficiently high for the catalyst material to melt, and sintering the diamond grains to form PCD material. In some embodiments of the invention, the pressure is at most about 15 GPa, or at most 8 GPa, or at most about 7.7 GPa, or at most about 7.5 GPa, or at most about 7.2 GPa or at most about 7.0 GPa.

In some embodiments of the method, the temperature may be in the range from about 1,350 degrees centigrade to about 2,300 degrees centigrade, in the range from about 1,400 degrees centigrade to about 2,000 degrees centigrade, in the range from about 1,450 degrees centigrade to about 1,700 degrees centigrade, or in the range from about 1,450 degrees centigrade to about 1,650 degrees centigrade.

In some embodiments of the method, the PCD material may be sintered for a period in the range from about 2 minutes to about 60 minutes, in the range from about 3 minutes to about 30 minutes, or in the range from about 5 minutes to about 15 minutes.

In some embodiments, the aggregated mass and the binder material are mixed in powder form with appropriate binding aids.

In some embodiments the binder material is infiltrated into the aggregated mass.

In some embodiments, the diamond particles can be coated with the binder material using techniques such as sol-gel, electrolytic or electroless deposition, PVD, or CVD. The coatings can be continuous or dispersed.

In some embodiments, infiltration using shims, powders, discs or from a substrate containing the binder material can be used.

In some embodiments, the binder material is cobalt-tungsten carbide.

In some embodiments, the binder material is Ni, Pd, Mn or Fe, or combinations of these metal catalysts with one or other of these catalysts and/or with Co.

In some embodiments, the diamond particles or grains prior to contact with the sintering additive or binder material have an average particle or grain size of from about 0.1 microns to about 50 microns, or from about 0.2 microns to about 10 microns, or from about 0.9 microns to about 2 microns.

In some embodiments, the body of polycrystalline diamond material is a stand-alone compact. In other embodiments, the polycrystalline diamond material is attached to a substrate, such as a metal carbide substrate, for example.

### BRIEF DESCRIPTION OF THE FIGURES

The present invention will now be described by way of example only and with reference to the accompanying drawings in which:

FIG. 1 is a graph showing the variation of carbon concentration with diamond particle diameter;

FIG. 2 is an interval plot of diamond contiguity; and

FIG. 3 is a sniper plot of abrasion test results showing standard PCD (NEP-Std), PCD containing UDD (NEP-UDD) and PCD containing crushed nanodiamond (NEP-CND).

### DETAILED DESCRIPTION OF EMBODIMENTS

As used herein, “polycrystalline diamond” (PCD) material comprises a mass of diamond grains, a substantial portion of which are directly inter-bonded with each other and in which the content of diamond is at least about 80 volume percent of the material. In one embodiment of PCD material, interstices between the diamond grains may at least partly be filled with a binder material.

As used herein, “catalyst material for diamond” is a material that catalyses intergrowth of polycrystalline diamond particles or grains under conditions of temperature and pressure at which diamond is more thermodynamically stable than graphite.

As used herein, “interstices” or “interstitial regions” are regions between the diamond grains of PCD material.

As used herein, a “green body” is an article that is intended to be sintered or which has been partially sintered, but which has not yet been fully sintered to form an end product. It may generally be self-supporting and may have the general form of the intended finished article.

As used herein, a “superhard wear element” is an element comprising a superhard material and is for use in a wear application, such as degrading, boring into, cutting or machining a workpiece or body comprising a hard or abrasive material.

As used herein, the words “average” and “mean” have the same meaning and are interchangeable.

In the field of quantitative stereography, particularly as applied to cemented carbide material, “contiguity” is understood to be a quantitative measure of inter-phase contact. It is defined as the internal surface area of a phase shared with grains of the same phase in a substantially two-phase microstructure (Underwood, E. E, “Quantitative Stereography”, Addison-Wesley, Reading Mass. 1970; German, R. M. “The Contiguity of Liquid Phase Sintered Microstructures”, Metallurgical Transactions A, Vol. 16A, July 1985, pp. 1247-1252). As used herein, “diamond grain contiguity” is a measure of diamond-to-diamond contact or bonding, or a combination of contact and bonding within PCD material.

As used herein, “nanodiamond” and “nano-sized carbon source” are particles or grains that have their major diametric dimension of 0.1 microns (100 nm) or less.

As used herein, UDD is “ultra-dispersed nanodiamond”, consisting of diamond particles of 2-50 nm, and produced by detonation of carbon-containing explosives. UDD particles typically consist of a polycrystalline diamond core surrounded by a metastable (non-diamond) carbon shell.

As used herein, PDD is “polycrystalline detonated diamond powder”, also known as “poly-dispersed diamond” comprising particles that may be as small as 0-50 nm, typically consisting of polycrystalline nanodiamond grains of about 20-25 nm that are produced by shock-wave compression of carbon materials mixed with catalyst. PDD typically contains non-carbon impurities from the catalyst, for example copper.

As used herein, “crushed source nanodiamond” is synthetic (synthesised at HPHT conditions) or natural micron-sized diamond that has been ground, purified and graded to yield nanosized fractions of monocrystalline diamond particles.

In some embodiments, the body of PCD material has a diamond content of from 80 to 95 volume percent and a binder content of at least 5 volume percent, and comprises diamond grains having a mean diamond grain contiguity of greater than 60 percent and a standard deviation of less than 2.2 percent. The diamond grains form a skeletal mass defining interstices or interstitial regions between them. The combined lengths of lines passing through all points lying on all bond or contact interfaces between diamond grains within a section of the PCD material are summed to determine the diamond perimeter, and the combined lengths of lines passing through all points lying on all interfaces between diamond and interstitial regions within a section of the PCD material are summed to determine the binder perimeter.

As used herein, “diamond grain contiguity” κ may be calculated according to the following formula using data obtained from image analysis of a polished section of PCD material:

κ=100*[2*(δ−β)]/[(2*(δ−β))+δ],

where δ is the diamond perimeter, and β is the binder perimeter.

As used herein, the diamond perimeter is the fraction of diamond grain surface that is in contact with other diamond grains. It is measured for a given volume as the total diamond-to-diamond contact area divided by the total diamond grain surface area. The binder perimeter is the fraction of diamond grain surface that is not in contact with other diamond grains. In practice, measurement of contiguity is carried out by means of image analysis of a polished section surface. The combined lengths of lines passing through all points lying on all diamond-to-diamond interfaces within the analysed section are summed to determine the diamond perimeter, and analogously for the binder perimeter.

Images used for the image analysis should be obtained by means of scanning electron micrographs (SEM) taken using a backscattered electron signal. Optical micrographs may not have sufficient depth of focus and may give substantially different contrast. The method of measuring diamond grain contiguity requires that distinct diamond grains in contact with or bonded to each other can be distinguished from single diamond grains. Adequate contrast between the diamond grains and the boundary regions between them may be important for the measurement of contiguity since boundaries between grains may be identified on the basis of grey scale contrast. Boundary regions between diamond grains may contain included material, such as catalyst material, which may assist in identifying the boundaries between grains.

A multimodal size distribution of a mass of grains is understood to mean that the grains have a size distribution with more than one peak, each peak corresponding to a respective “mode”. Multimodal polycrystalline bodies are typically made by providing more than one source of a plurality of grains, each source comprising grains having a substantially different average size, and blending together the grains. Measurement of the size distribution of the blended grains may reveal distinct peaks corresponding to distinct modes. When the grains are sintered together to form the polycrystalline body, their size distribution is further altered as the grains are compacted against one another and fractured, resulting in the overall decrease in the sizes of the grains. Nevertheless, the multimodality of the grains may still be clearly evident from image analysis of the sintered article.

Unless otherwise stated herein, dimensions of size, distance, and perimeter and so forth relating to grains and interstices within PCD material, as well as the grain contiguity, refer to the dimensions as measured on a surface of, or a section through a body comprising PCD material and no stereographic correction has been applied. For example, the size distributions of the diamond grains of embodiments of the invention were measured by means of image analysis carried out on a polished surface, and a Saltykov correction was not applied.

In measuring the mean value and deviation of a quantity such as grain contiguity, or other statistical parameter measured by means of image analysis, several images of different parts of a surface or section are used to enhance the reliability and accuracy of the statistics. The number of images used to measure a given quantity or parameter may be at least about 9 or even up to about 36. The number of images used may be, for example, about 16. The resolution of the images needs to be sufficiently high for the inter-grain and inter-phase boundaries to be clearly made out. In the statistical analysis, typically 16 images are taken of different areas on a surface of a body comprising the PCD material, and statistical analyses are carried out on each image as well as across the images. Each image should contain at least about 30 diamond grains, although more grains may permit more reliable and accurate statistical image analysis.

Catalyst material may be introduced to an aggregated mass of diamond grains for sintering in any of the ways known in the art. The PCD may be backed by a substrate, and the binder may be infiltrated from the substrate during HPHT synthesis, or be infiltrated from a shim, foil or layer of alternative binder material at the interface between the PCD layer and the substrate. The

PCD may be unbacked, in which case the binder may be introduced via known methods in the art such as mixing, milling or coating of the diamond powder with the binder material, or may be infiltrated from a substrate, foil, layer or shim which may be removed after sintering. The PCD may be leached or unleached. The binder may be Co-WC or other binder materials known in the art such as for example Ni, Pd, Mn or Fe or combinations of these. The interface between the PCD table and the substrate may be planar or non-planar/shaped. The PCD table may have a chamfered edge.

In one embodiment, the aggregated mass of diamond grains and sintering additive, together with the catalyst or binder material, may be formed into a green body, which may be placed onto a cemented carbide substrate. The cemented carbide substrate may contain a source of catalyst material for diamond, such as cobalt. The assembly of aggregated mass and substrate may be encapsulated in a capsule suitable for an ultra-high pressure furnace apparatus capable of subjecting the capsule to a pressure of greater than 6 GPa. Various kinds of ultra-high pressure apparatus are known and can be used, including belt, toroidal, cubic and tetragonal multi-anvil systems. The temperature of the capsule should be high enough for the source of catalyst material to melt and low enough to avoid substantial conversion of diamond to graphite. The time should be long enough for sintering to be completed and for the entire sintering additive to be consumed.

In one embodiment, the binder material is combined with a first fraction of coarser diamond particles or grains and a second fraction of nano-sized diamond particles or grains in powder form. It may be mixed in a conventional mixing process such as, for example, a planetary ball milling process, typically in the presence of a milling aid such as an alcohol for example, methanol. Milling balls, such as Co-WC milling balls, are used to mill the binder and diamond powders together. The binder and diamond mixture is then typically dried at a temperature of 50 to 100° C. to remove the milling aid such as alcohol and other volatile residues and water, for example by freeze drying the mixture. The resultant aggregated mass may then be consolidated into a green body ready for sintering.

Prior to contact with the binder material, the diamond particles of the coarser fraction may have an average particle size ranging from about 0.1 microns to about 50 microns.

The green body, once formed, may be placed in a suitable container and introduced in to a high pressure and high temperature press. Pressure and heat are applied in order to sinter the diamond particles together, typically at pressures of 6 GPa or more and temperatures of 1350° C. or more.

Sintering is carried out for a time sufficient for all of the nano-sized diamond particles or grains to be consumed, such that substantially no nano-structures are to be found in the sintered PCD material.

The diamond grain sizes in the sintered PCD may range from about 0.1 microns to about 50 microns, or from about 0.2 microns to about 10 microns, or from about 0.9 microns to about 2 microns.

Diamond contiguity is an important performance indicator, as it indicates the degree of intergrowth or bonding between the diamond particles, and all else being equal the higher the diamond contiguity the better the cutter performance. Higher diamond contiguity is normally associated with high diamond content which in turn results in lower binder content, as the high diamond content translates into low porosity and therefore low binder content, as the binder occupies the pores.

According to classic materials science of composite materials, low binder content results in low fracture toughness, as it is normally the hard grains (in this case diamond) that imparts hardness to the composite material, and the more ductile binder (in PCD, normally Co-WC) that imparts toughness to the composite material.

Therefore, high diamond content and low binder content are expected to be associated with increased hardness and decreased toughness, so that failure due to fracture or spalling of the PCD is expected to increase.

It was therefore surprising to find that PCD with improved wear performance can be obtained by adding nanodiamond particles to the green body prior to sintering at HPHT. The nanodiamond particles are not evident in the final product, so that they perform the role of a sacrificial sintering additive. Using a nanodiamond additive in this way results in an unusual combination of diamond content, binder content and diamond contiguity, enabling an increase in diamond contiguity combined with a decrease in diamond content and an increase in binder content. This unusual combination is expected to result in improved wear performance without compromising toughness.

Wishing not to be bound by theory, due to its very small particle size, nanodiamond has a higher solubility than larger, micron-sized diamond, and it is believed that it is this property that makes it an effective sintering additive. During the HPHT sintering cycle, the nanodiamond is believed to dissolve preferentially to the larger diamond particles, probably dissolving sooner and resulting in a higher carbon concentration dissolved in the molten metal than would be the case with the larger diamond particles. As it dissolves sooner, less of the original large tightly packed diamond particles are lost to dissolution, and the higher carbon concentration in the molten metal means a higher supersaturation level is obtained which facilitates crystallisation or precipitation of the dissolved carbon as newly formed diamond that bonds the diamond particles together.

The solubility of carbon in cobalt may be expressed by the following formula:

(C/Co)=exp [(2 γsl×Vm)/RT×1/r], where:
γsl=interfacial energy
Vm=molar volume
R=gas constant
T=Temperature

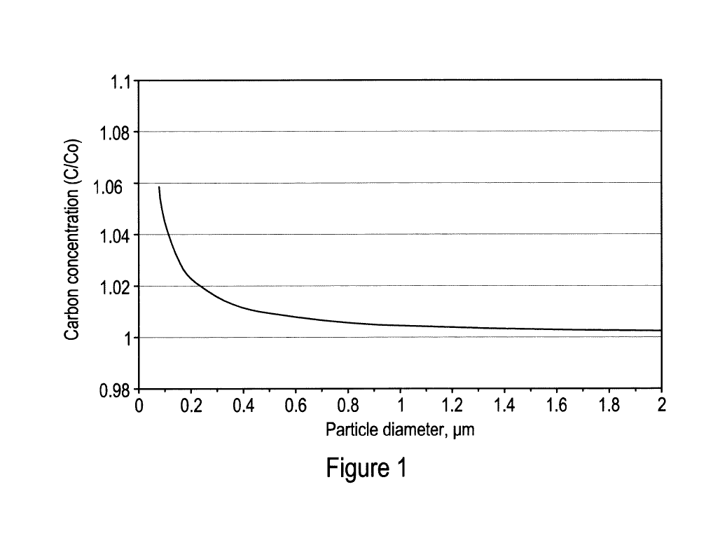

As the grain size decreases, the solubility of carbon in cobalt increases, as shown in FIG. 1 which is a plot illustrating the dependence of the solubility on grain size. The solubility of the nanodiamond in a cobalt matrix is extreme, and according to the above equation and graph, it will be consumed during the sintering process.

### EXAMPLES

Some embodiments are discussed in more detail below with reference to the following examples, which are not intended to be limiting.

### Example 1

A PCD cutter was formed by the following method. 1 g of UDD was added to 99 g of a bimodal diamond powder. The aggregated mass was ball milled in 10 ml of methanol with Co-WC milling balls. The ratio of milling balls:powder was 4:1 and the milling was carried out at 90 rpm for 1 hour. 2 g of this mix was placed on top of a Co-WC substrate and sintered under HPHT conditions at 6.8 GPa and 1450° C. for 10 minutes dwell time at maximum temperature. The PCD cutter was recovered and processed.

### Example 2

A further PCD cutter was formed by the following method. 1 g of crushed nanodiamond was added to 99 g of a bimodal diamond powder. The aggregated mass was ball milled in an aqueous medium with Co-WC milling balls. The ratio of milling balls:powder was 4:1 and the milling was carried out at 90 rpm for 1 hour. The mix was then freeze dried to remove residual water. 2 g of this mix were placed on top of a Co-WC substrate and sintered under HPHT conditions at 6.8 GPa and 1450° C. for 10 minutes dwell time at maximum temperature. The PCD cutter was recovered and processed.

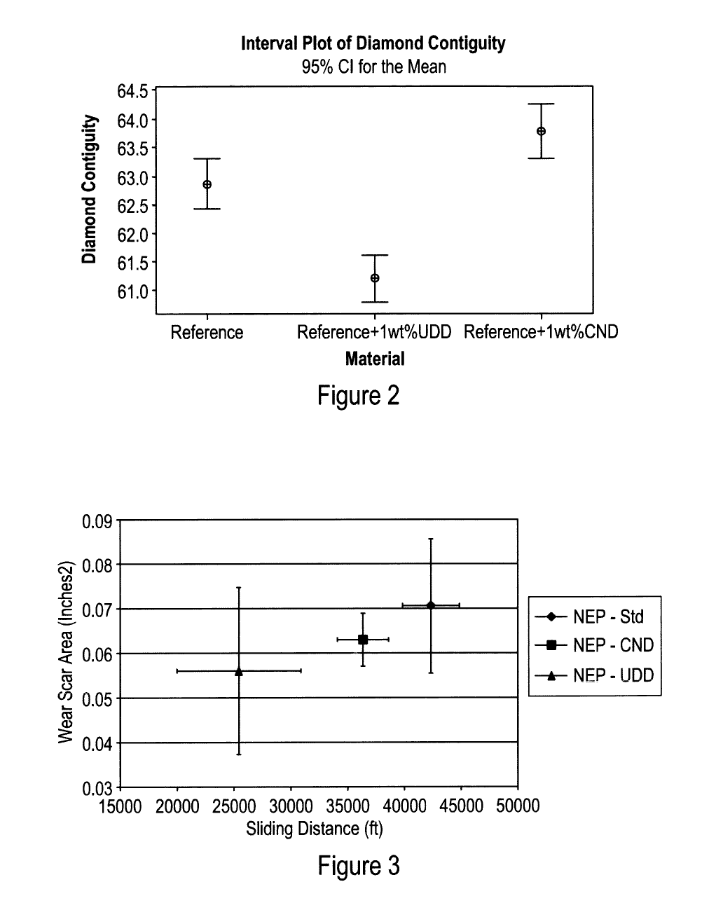

Image analysis was carried out on scanning electron micrographs of polished samples of the PCD produced in the above examples, and the results are shown in FIG. 2.

The diamond contiguity for the PCD containing crushed nanodiamond as the source of nano diamond in the sintering mixture was found to be much higher than the standard base PCD.

The abrasion test sniper plot is shown in FIG. 3. According to the graph, the PCD containing crushed nanodiamond as the source of nano diamond in the sintering mixture clearly shows a greater performance as compared to the base PCD.

A combination of the image analysis data and the abrasion test shows that the sample having a higher diamond contiguity performs better in the abrasion test.

1. A body of polycrystalline diamond (PCD) material having a diamond content of at most about 95 percent of the volume of the PCD material, a binder content of at least about 5 percent of the volume of the PCD material, and comprising diamond grains having a mean diamond grain contiguity of greater than about 60 percent and a standard deviation of less than about 2.2 percent.

2. A polycrystalline diamond material according to claim 1, wherein the binder material comprises at least 12 volume percent of the PCD material.

3. A polycrystalline diamond material according to claim 1, wherein the diamond particles or grains have an average particle or grain size of from about 0.1 microns to about 50 microns.

4. A polycrystalline diamond material according to claim 1, wherein the diamond content of the polycrystalline diamond material is at least 80 percent and at most 88 percent of the volume of the polycrystalline diamond material.

5. A wear element comprising a polycrystalline diamond material according to claim 1.

6. A method for making a body of polycrystalline diamond material, the method comprising providing a fraction of diamond particles or grains and a sintering additive, the sintering additive comprising a carbon source of nano-sized particles or grains, forming the diamond particles and sintering additive into an aggregated mass, consolidating the aggregated mass and a binder material, typically a catalyst material for diamond, to form a green body, and subjecting the green body to conditions of pressure and temperature at which diamond is more thermodynamically stable than graphite and for a time sufficient to consume the sintering additive, sintering it and forming a body of polycrystalline diamond material that is thermodynamically and crystallographically stable and is substantially devoid of any nano-structures, the body of polycrystalline diamond (PCD) material having a diamond content of at most about 95 percent of the volume of the PCD material, a binder content of at least about 5 percent of the volume of the PCD material, and comprising diamond grains having a mean diamond grain contiguity of greater than about 60 percent and a standard deviation of less than about 2.2 percent.

7. A method according to claim 6, wherein the sintering additive is nanodiamond.

8. A method according to claim 7, wherein the nanodiamond is UDD, PDD or a crushed source of nanodiamond.

9. A method according to claim 6, wherein the method includes subjecting the green body to a pressure of about 6.0 GPa or more and a temperature of about 1350° C. or more.

10. A method according to claim 6, wherein the PCD material is sintered for a period of 2 minutes to 60 minutes.

11. A method according to claim 6, wherein the diamond particles or grains, prior to contact with the sintering additive or binder material, have an average particle or grain size ranging from about 0.1 microns to about 50 microns.

12. A method according to claim 6, wherein the sintering additive is a nano-sized carbon source selected from the group comprising graphite, soot, coke, carbon anions and fullerenes.

13. A method according to claim 6, wherein the sintering additive is provided in an amount of from about 0.01 to about 5 wt %, or from about 0.5 to about 1 wt %, or up to about 50 wt %.

14. A method according to claim 6, wherein the binder material is Ni, Pd, Mn or Fe, or combinations of these metal catalysts with one or other of these catalysts and/or with Co.

15. A method according to claim 6, wherein the diamond particles or grains prior to contact with the sintering additive or binder material have an average particle or grain size of from about 0.1 microns to about 50 microns, or from about 0.2 microns to about 10 microns, or from about 0.9 microns to about 2 microns.
